(19) United States
(12) Patent Application Publication
(10) Pub. No.: US 2026/0147317 A1
(43) Pub. Date: May 28, 2026

(54) SYSTEMS, APPARATUS, AND METHODS FOR AUTOMATICALLY TESTING SMART WATCH DEVICES

(71) Applicant: Communications Test Design, Inc., West Chester, PA (US)

(72) Inventor: Ritvik TIWARI, King Of Prussia, PA (US)

(73) Assignee: Communications Test Design, Inc., West Chester, PA (US)

(21) Appl. No.: 18/956,120

(22) Filed: Nov. 22, 2024

(51) Int. Cl. G04D 7/00; G04G 99/00

(52) U.S. Cl. CPC G04D 7/003; G04D 7/006; G04G 99/006

(57) ABSTRACT

Systems, apparatus, and methods for automatically testing smart watch devices are shown and described. The apparatus for testing a smart watch includes a cabinet having a first compartment, wherein the first compartment has and interior volume. The first compartment having signal/sound dampening material positioned around the perimeter of the interior of the first compartment. A smart watch fixture is secured within the interior volume of the first compartment. The smart watch fixture is configured to have a smart watch removably secured therein. A mobile device is secured within the first compartment. The mobile device is secured such that the camera of the mobile device is targeted at the smart watch fixture. The apparatus includes a computer allowing for the mobile device to be operably coupled thereto.

### BACKGROUND OF THE INVENTION

Technology is always advancing and has done so at a rapid pace for the last several decades. Technology has become sophisticated, smaller, and accessible across the globe. This has led to technology becoming integral in everyday life. As with any integral element of life, the demand is high. This high demand has led to a rise in the cost of technological devices.

In addition to high demand, the simple replacement of devices can be expensive. If one merely discards older equipment or equipment with minor defects for a brand-new piece the cost can escalate quickly. If, however, technology is upgraded, or repaired this process can be much more cost effective for both the company and consumer.

One form of technology which is in high demand are smart watches. Smart watches like mobile devices are able to be traded in and resold as used or refurbished. These smart watches can still fetch a decent amount and create a second profit for any business willing to accept trading of devices. However, in order to resell the device, or repair then resell the device, tests must be performed to determine the functionality of the device.

In many instances devices are manually tested. Manually testing devices has many drawbacks such as, the time it takes to test, the accuracy of the testing, and the potential to have false pass rates. Manually testing items such as speakers and microphones can lead to an individual passing a device even through the speakers are faulty. Further, it can take a tremendous amount of time to test multiple devices because each device will have to be tested one at a time.

Many companies have been taking advantage of the repair instead of discard philosophy. Further, many consumers are happy purchasing a lightly used and repaired device instead of a brand new one. However, these processes come with new challenges in order to remain effective. Consequently, there is always a need for an improvement in the art.

### SUMMARY OF THE INVENTION

The present invention provides a systems, apparatus, and methods for automatically testing smart watch devices wherein the same can be utilized for testing and certifying the functionality of a smart watch. The apparatus for testing a smart watch includes a cabinet having a first compartment. The first compartment has and interior volume. A smart watch fixture is secured within the interior volume of the first compartment. The smart watch fixture is configured to have a smart watch removably secured therein. A mobile device is secured within the first compartment. The mobile device is secured such that the camera of the mobile device is targeted at the smart watch fixture.

Another object of the apparatus for testing a smart watch is have signal/sound dampening material positioned around the perimeter of the interior of the first compartment.

Another object of the apparatus for testing a smart watch is have a camera secured within the first chamber.

Another object of the apparatus for testing a smart watch is have the camera positioned such that it is targeted at the screen of the mobile device.

Another object of the apparatus for testing a smart watch is have a plurality of platforms secured within the first chamber. The smart watch fixture is secured on a first platform. The mobile device is secured to a second platform which is positioned above the first platform.

The Another object of the apparatus for testing a smart watch is have the smart watch fixture operably coupled to a first actuator.

Another object of the apparatus for testing a smart watch is have the first actuator operably coupled to a second actuator.

Another object of the apparatus for testing a smart watch is have a computer which has the mobile device operably coupled thereto.

Another object of the apparatus for testing a smart watch is have a second compartment having an interior volume. A smart watch fixture is secured within the interior volume of the second compartment, wherein the smart watch fixture is configured to have a smart watch removably secured therein. A mobile device is secured within the second compartment. The mobile device is secured such that the camera of the mobile device is targeted at the smart watch fixture.

Other objects, features and advantages of the present invention will become apparent from the following detailed description taken in conjunction with the accompanying drawings.

### BRIEF DESCRIPTION OF THE DRAWINGS

The accompanying drawings are incorporated in and are to be considered part of the present specification. These drawings are meant to aid the reader's understanding and comprehension of the present disclosure and are depictions of various example embodiments. The drawings are not to be considered limiting upon the disclosure. It should specifically be noted that the drawings are examples and may not necessarily be drawn to scale.

FIG. 1 shows a block diagram of a computing system.

FIG. 2A shows a front view of an example of a smart watch device.

FIG. 2B shows a rear view of an example of a smart watch device.

FIG. 3 shows a perspective front view of an embodiment of an apparatus for testing a smart watch device.

FIG. 4 shows a perspective view of an embodiment of the interior of the apparatus for testing a smart watch device.

FIG. 5 shows a flow chart of an embodiment of the method for testing a smart watch device.

### DETAILED DESCRIPTION OF THE INVENTION

For the purposes of presenting a brief and clear description of the present invention, a preferred embodiment will be discussed as used for the systems, apparatus, and methods for automatically testing smart watch devices. The figures are intended for representative purposes only and should not be considered to be limiting in any respect.

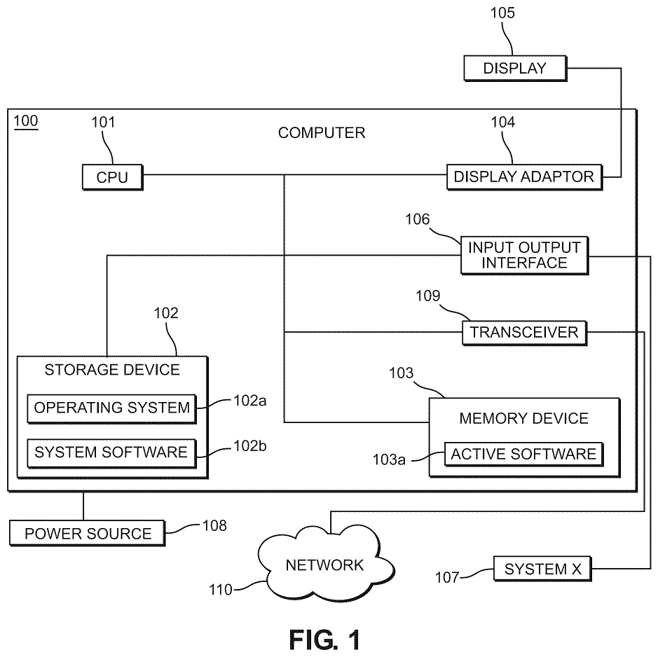

Referring now to FIG. 1, there is shown a block diagram of a computing system. Computing systems may have many interchangeable parts or multiples of some parts. One of ordinary skill in the art will understand that the shown computer 100 is a basic computing system demonstrating a minimal amount of parts to allow for the computer to function. Computer 100 is exemplary, and one of ordinary skill in the art will recognize that computer 100 may be altered as necessary to render the presently disclosed system operable or to provide a peak performance of the disclosed system.

The parts described are each operably coupled together as necessary, one of ordinary skill in the art will understand how to connect general computer components, for example by use of a mother board or other computer board. In the shown embodiment the computer 100 includes a CPU 101. In one embodiment the CPU 101 includes only one processor. In other embodiments the CPU 101 may be made up of multiple processors. Different processors will allow for different computing power and speed.

The computer 100 includes at least one storage device 102. In different embodiments the at least one storage device 102 may be a solid-state storage device, a disk storage device, or another suitable storage device. One of ordinary skill in the art will recognize that there are several types of computing storage devices each providing well-known benefits and drawbacks. The at least one storage device 102 will store at least the computer operating system 102a and system software 102b. System software 102b may include any software necessary, or optionally, used to run any system described herein.

The computer 100 will have at least one memory device 103. One of ordinary skill in the art will recognize that there are several types of computing memory devices each providing well known benefits and drawbacks. The at least one memory device 103 will store at any active software 103a. Active software 103a may include the operating system 102a or parts of the system software 102b. The at least one memory device 103 may store the entire system software 102b size and speed permitting.

The computer 100 may also include various connection ports and types. The computer 100 may have a display adaptor 104. The display adaptor 104 will allow the computer 100 to connect to at least one display 105. In other embodiments multiple displays may be connected to the display adaptor 104. Similarly, the computer 100 may include at least one input/output interface 106. The input/output interface 106 will allow the computer 100 to connect to at least one system, referred to as System X 107 in FIG. 1. The input/output interface 106 may also allow for connection to only part of System X 107 or multiple systems. The computer 100 will also be operably connected to a required power source 108.

The computer 100 may also include a transceiver 109. In one embodiment the transceiver 109 is a wired transceiver. In another embodiment the transceiver 109 is a wireless transceiver. The transceiver 109 will allow the computer 100 to connect to a network 110. The network 110 may be an internet or an intranet connection. The network 110 will allow for the computer 100 to potentially connect to multiple other computing devices. In another embodiment the network may allow for the computer 100 to connect to multiple systems. In one embodiment the computer 100 will allow for System X 107 to be connected to the network 110.

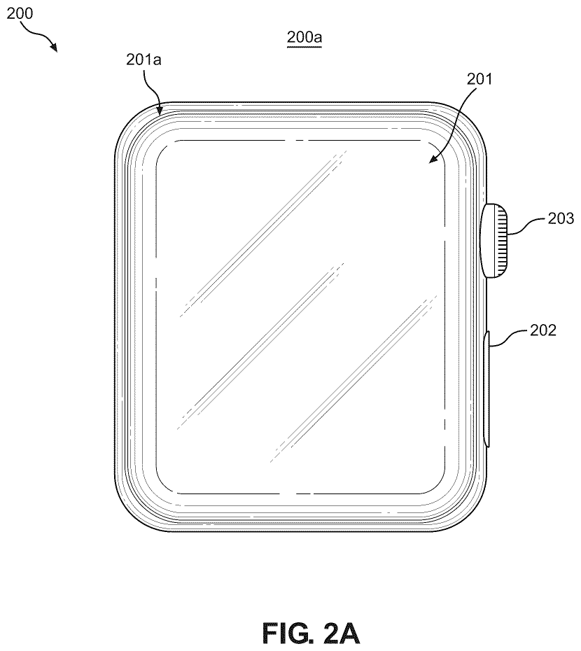

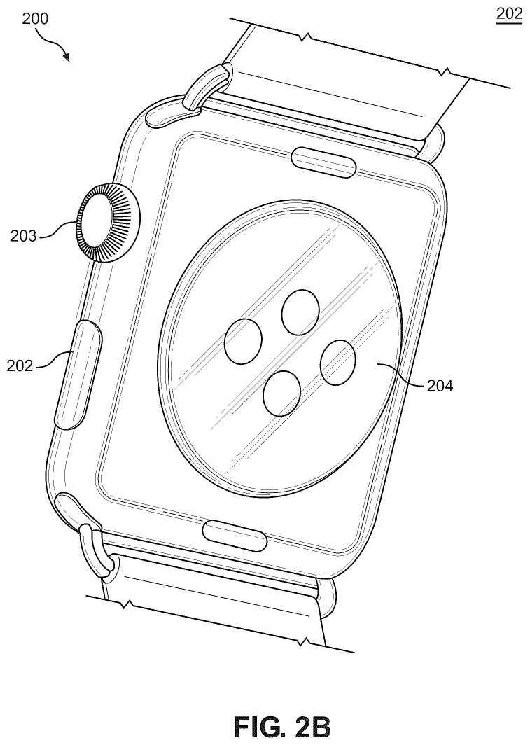

Referring now to FIG. 2A and FIG. 2B, there is shown front and rear views of a smart watch device. A smart watch device 200 includes a front side 200a having a screen 201. In many embodiments the screen 201 takes up much of the front of the smart watch device 200. In some embodiments there is a bezel or other item 201a surrounding the perimeter of the screen 201. Often times the scree 201 is a touch screen allowing inputs into the smart watch device via a touch of the screen 201.

In many embodiments the smart watch device 200 includes at least one button 202. The at least one button 202 may have any number of functions. For example, the at least one button 202 may control: the power of the device, the volume of the device, may serve as a go back button, may start or stop a stopwatch, or any other necessary function for watches. In some embodiments the smart watch device 200 includes a knob 203. The knob 203 may also have similar controls to the at least one button 201.

A back 200b of the smart watch device 200 may include any combinations of various components. Often times the back 200b includes a heartbeat sensor 204. Often times the heartbeat sensor 204 shows as a green light when activated. In some embodiments a camera may be included on the back 200b.

In many embodiments smart watch devices 200 also include a plurality of sensors located within the smart watch. These sensors may include: a gyroscope, an accelerometer, a barometer, and an altimeter. Further, smart watches have a CPU operably coupled with a memory and at least one wireless transceiver. Smart watches also include a speaker and a microphone, each located within the smart watch.

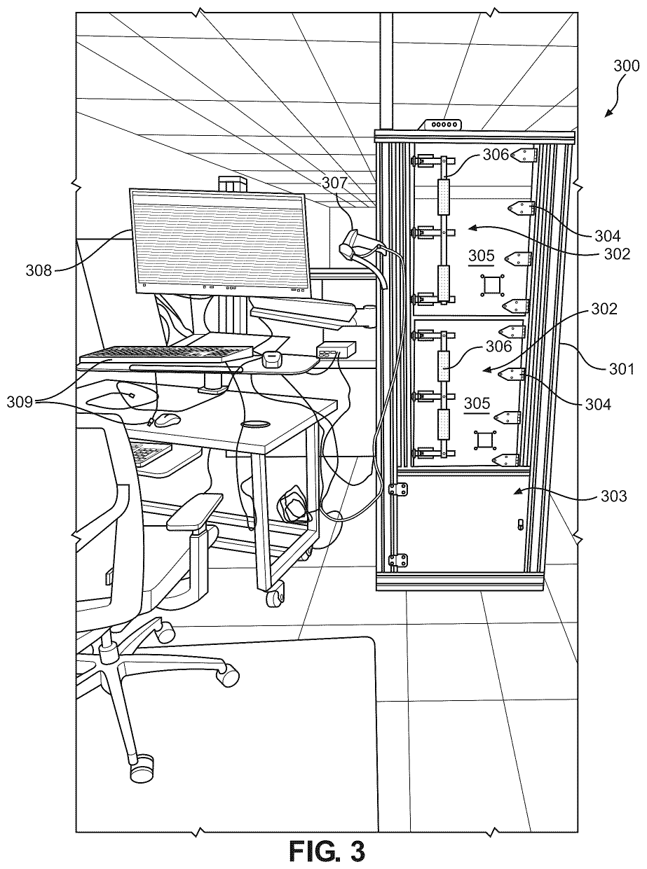

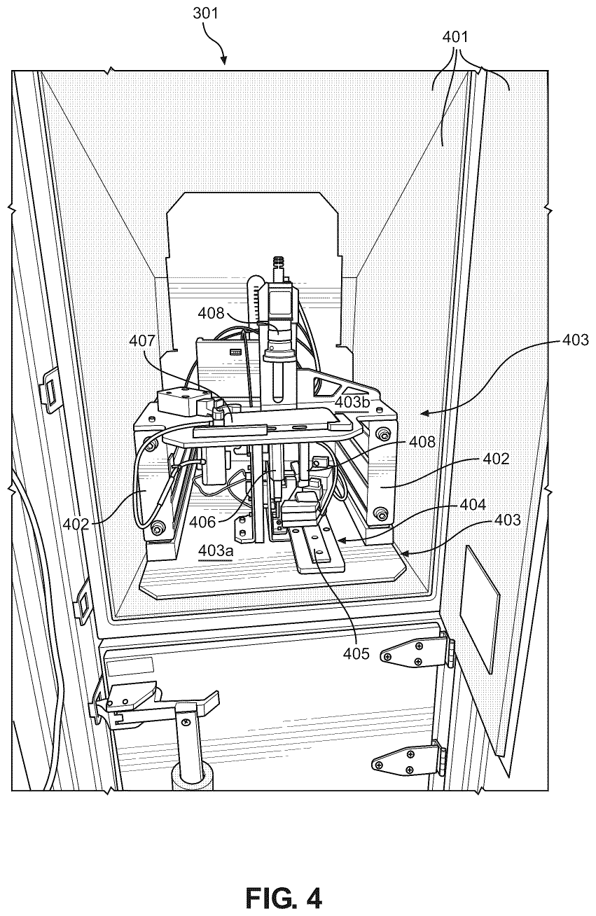

Referring now to FIG. 3, there is shown a perspective front view of an embodiment of an apparatus for testing a smart watch device. The apparatus for testing a smart watch 300 is comprised of a cabinet 301 having at least one compartment. In the shown embodiment the cabinet is comprised of three compartments. A first type of compartment 302 as will be further described in the description of FIG. 4 and a second type of compartment 303. In the shown embodiment the second type of compartment 303 is located at eh bottom of the cabinet 301. The second type of compartment 303 is configured to hold computer components as necessary for the function of the apparatus for the testing a smart watch 300.

In the shown embodiment there are two of the first type of compartment 302 shown above the second type of compartment 303. The first type of compartment 302 includes at least one hinge 304 connecting at least one door 305 to the cabinet. Each first type of compartment 302 also includes a door handle 306 which allows for the door to be open and closed.

The system also has a scanner 307 which is secured to the cabinet 301 and operably coupled to the computer via the system X connection. In addition the system includes a display screen 308 and at least one input device 309. Each the display screen 308 and the at least one input device 309 are operably coupled to the computer via the system x connection.

Referring now to FIG. 4, there is shown a perspective view of an embodiment of the interior of the apparatus for testing a smart watch device. The interior of the first type of compartment 301 has a wireless signal dampening material 401. In some embodiments the signal/sound dampening material 401 will prevent any wireless signal from passing through the walls of the first type of compartment 301 when the door is in the closed position.

In some embodiments the interior of the of the first compartment 301 will include various types of supports and other structure to support the components described herein. In the shown embodiment there are several supports 402 and two platforms 403. The first platform 403a supports a first actuator 404. The first actuator 404 has a watch fixture 405 secured thereto. The watch fixture 405 is configured to removably secure a watch therein. The first actuator 404 moved the watch fixture forward toward the door of the cabinet 301 and back into the cabinet 301.

A second actuator 406 is secured to the first actuator 404. The second actuator 406 moves the first actuator 404 and the watch fixture 405 up and down between the first platform 403a and a second platform 403b. This enables the watch to be moved when testing the altimeter for example. Further, a stylus 409 is secured to the second platform 403b. The stylus 409 points down toward the watch fixture 405. Using the first actuator 404 and the second actuator 406 the watch can be moved into contact with the stylus 409.

The second platform 403b supports a mobile phone 407. The mobile phone 407 is positioned such that the phone screen is pointed away from the watch fixture 405 and the phone's camera is pointed down toward the watch fixture 405. This positioning of the camera allows for the camera to be used in the testing sequence. The mobile phone has a testing application stored in its non-transient storage medium. This testing application is configured to run the automatic testing sequence as described below. The mobile phone is operably coupled to the computer of FIG. 1 via System X. In one embodiment the mobile phone is operably coupled to a microprocessor. The microprocessor may function as an automated virtual keyboard. This will allow for the necessary actions to be taken via automation.

In addition to the phone 407 the second platform 403b supports a camera 408. The camera 408 is positioned such that it points toward the phone screen. The camera 408 and the phone 407 are operably coupled together in such a manner where the camera can confirm the phone 407 is on the expected screen (graphical user interface page) throughout the testing sequence. This will ensure that in embodiments which use the automated keyboard the correct actions are being performed on the correct screens. If a screen does match the actions to be taken then the test can be restarted.

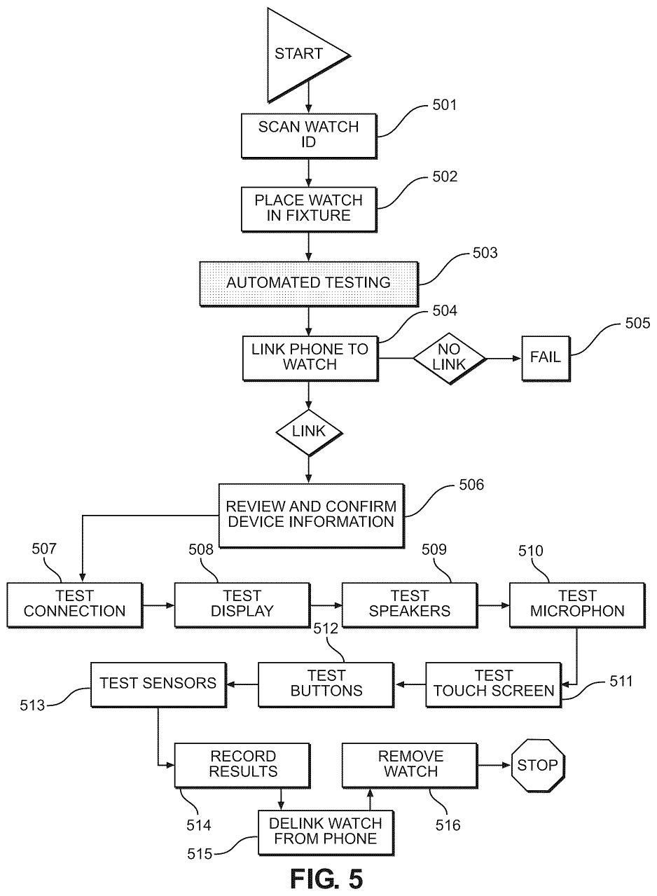

Referring now to FIG. 5, there is shown a flow chart of an embodiment of the method for testing a smart watch device. The method begins by scanning the ID of the watch to be tested 501. This ensures that the test results are properly associated with the watch. Further, the watch ID is used for further testing through this method.

Once the watch ID has been scanned 501, the watch is placed in the watch fixture of the testing unit 502. In one embodiment the watch fixture will automatically slide out of the cabinet to allow for easier placement of the watch. Once the watch is placed the watch fixture will then slide back into the cabinet. After the watch is placed in the watch fixture the cabinet door is closed and secured closed.

The automated testing can now begin 503. The first step is to link the watch to the phone within the cabinet. As described above, the phone has a testing application loaded thereon to facilitate this connection. In addition to the testing application the phone is configured to have an automated keyboard control feature. This allows for the phone to automatically run the connection sequence without human intervention. In addition, in one embodiment, during the entire automated testing process the camera which is pointed at the phone's screen can continuously monitor the screen to ensure it is at the appropriate screen and the tasks are being performed as expected. This feature helps ensure that accidental failures do not occur.

If the watch does not link to the phone the watch fails 505 the testing. If the watch does connect to the phone the watches information is reviewed 506. This ensures that the scanned information from the previous step matches the actual watch information. Next the system tests the connections to the watch 507. In different embodiments different connections may need to be tested. This depends upon what connections are possible given the watch model. In general the watches Bluetooth connectivity will be tested. Then the WIFI connectivity will be tested. Finally, if applicable the connection to a mobile network, such as an LTE connection will be tested. In each of these embodiments the connections are tested by sending a signal to the device. The name and signal strength of the signal can be read from the watch. If the network name and signal come back as expected then the test can be passed.

The display of the watch is tested to ensure that the display does not contain any errors 508. The display is tested by instructing the display to show a set of predetermined pictures or colors. The phone then takes a picture of each shown item. The application on the phone then inspects the pictures and compares them to a predetermined expected result. If the inspection reveals a result outside the acceptable range of compared values, then the display is failed.

The audio or speaker(s) of the watch are then tested 509. In order to test the speaker, the watch is instructed to play predetermined tones at specific volumes. The mobile phone can record the output of the watch's speakers. The recording is then compared to a prerecorded expected result. If the comparison results in a watch playing tones which are outside of the expected range, then the watch fails the test.

If the watch has a microphone, it is tested now 510. The microphone is tested in the reverse manner than that of the watch's speaker. For this test, the phones speakers play a predetermined set of tones. The watch is set to record the sounds played by the phone. The application then compares the recording to the predetermined expected results. If the recording is out side of the expected range, then the watch fails the test.

The watches touch screen can now be tested 511. The touch screen is tested using the stylus as described above. The stylus is used to touch the screen of the watch in a set of predetermined locations. The touches are recorded and compared to a set of predetermined coordinates. If a touch does not occur at an expected location, then the watch fails the test. Any number of touches may be used however, it has been found that 2 to 4 touches optimize test time and results.

In different embodiments different watches have various buttons. The proper function of these buttons also needs tested 512. The buttons are tested by an operator at the direction of the testing sequence. In some embodiments this sort of testing can be conducted in a quicker manner than via automation.

Lastly, the sensors of the watch are tested 513. In many cases watches include an accelerometer, an altimeter, and a barometer. Given the improvements in technology even very small changes can be recorded by these sensors. For example, to test the accelerometer the watch can be moved, even just a few inches. The movement will be recorded in a successful test. Similarly, the altimeter can be tested in the same manner, moving the watch in a vertical direction, by even just a few inches, can be recorded. Any recording of a change in vertical direction is a successful test. To test the barometer, the results of the recorded pressure by the watch's barometer can be compared to the recording of the phone's barometer, if these two records are within an acceptable range of difference the watch passes the test. In order to test the gyroscope, the watch can be tilted in an expected direction. If the gyroscope records the movement in the expected direction then, the watch passes the test.

In different embodiments the tests may be performed in a different order. Departing from the exact sequence as described does not change the nature of the invention. The described method is described in the order merely for convenience. The automated test may be performed in any order and still produce identical results. Similarly, the recording of the test results 514 may happen at this stage, after all of the tests have been performed. Alternatively, the test results can be recorded after each test. In some embodiments a user may determine that a single failed test equals a failed watch and cease testing. In other embodiments, testing may continue to receive a full record of pass/fail results.

After the tests are completed and the results are recorded 514, the watch is delinks from the phone 515. If the watch does not properly delink on the first attempt it enters a loop until it is no longer connected to the phone. After the watch is no longer connected it is removed from the tester 516. In one embodiment the watch fixture may slide out of the cabinet in order to allow for easier removal. At this point the watch has been tested and the method ends.

It is therefore submitted that the methods, systems, and devices have been shown and described in what is considered the most practical and preferred embodiments along with specific examples. It is recognized, however, that departures may be made within the scope and these present examples are not intended to be limiting. One of ordinary skill the art will be able to discern that obvious modifications can be made without departing from the scope or spirit.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, it is to be realized that, it is not intended for any method set forth herein to be construed as requiring that its steps be performed in a specific order, unless otherwise set forth in the claims.

Therefore, the foregoing is considered as illustrative only of the principles of the disclosure. Further, since numerous modifications and changes will readily occur to those skilled in the art, it is not desired to limit the invention to the exact construction and operation shown and described, and accordingly, all suitable modifications and equivalents may be resorted to, are deemed to fall within.

1) An apparatus for testing a smart watch, the apparatus comprises:
a Cabinet having a first compartment, wherein the first compartment has and interior volume;
a smart watch fixture is secured within the interior volume of the first compartment,
wherein the smart watch fixture is configured to have a smart watch removably secured therein;
a mobile device is secured within the first compartment,
wherein the mobile device is secured such that the camera of the mobile device is targeted at the smart watch fixture.

2) The apparatus for testing a smart watch of claim 1, further comprising signal/sound dampening material positioned around the perimeter of the interior of the first compartment.

3) The apparatus for testing a smart watch of claim 1, further comprising a camera secured within the first chamber.

4) The apparatus for testing a smart watch of claim 3, wherein the camera is positioned such that it is targeted at the screen of the mobile device.

5) The apparatus for testing a smart watch of claim 1, further comprising a plurality of platforms secured within the first chamber;
wherein the smart watch fixture is secured on a first platform; and
wherein the mobile device is secured to a second platform which is positioned above the first platform.

6) The apparatus for testing a smart watch of claim 1, wherein the smart watch fixture is operably coupled to a first actuator.

7) The apparatus for testing a smart watch of claim 6, wherein the first actuator is operably coupled to a second actuator.

8) The apparatus for testing a smart watch of claim 1, further comprising a computer, wherein the mobile device is operably coupled with the computer.

9) The apparatus for testing a smart watch of claim 1, further comprises a second compartment; wherein the second compartment has and interior volume;
a smart watch fixture is secured within the interior volume of the second compartment, wherein the smart watch fixture is configured to have a smart watch removably secured therein;
a mobile device is secured within the second compartment, wherein the mobile device is secured such that the camera of the mobile device is targeted at the smart watch fixture.

10. The apparatus for testing a smart watch of claim 9, further comprising signal/sound dampening material positioned around the perimeter of the interior of the second compartment.

11. The apparatus for testing a smart watch of claim 9, further comprising a camera secured within the second chamber.

12. The apparatus for testing a smart watch of claim 11, wherein the camera is positioned such that it is targeted at the screen of the mobile device.

13. The apparatus for testing a smart watch of claim 1, further comprising a plurality of platforms secured within the second chamber;
wherein the smart watch fixture is secured on a first platform; and
wherein the mobile device is secured to a second platform which is positioned above the first platform.

14. The apparatus for testing a smart watch of claim 9, wherein the smart watch fixture is operably coupled to a first actuator.

15. The apparatus for testing a smart watch of claim 14, wherein the first actuator is operably coupled to a second actuator.

16. The apparatus for testing a smart watch of claim 9, further comprising a computer, wherein the mobile device is operably coupled with the computer.
